(19) United States
(12) Patent Application Publication
(10) Pub. No.: US 2012/0258228 A1
(43) Pub. Date: Oct. 11, 2012

(54) PROCESS FOR PRODUCING AUTOCLAVED FOODSTUFFS IN A CONTAINER FORMED FROM A FLAT COMPOSITE HAVING A COLORED CROSS-LINKED OUTER POLYMER LAYER OBTAINABLE BY MEANS OF HIGH PRESSURE

(75) Inventors: Michael Wolters, Heinsberg (DE); Dirk Schibull, Heinsberg (DE)

(73) Assignee: SIG TECHNOLOGY AG, Neuhausen (CH)

(21) Appl. No.: 13/503,114

(22) PCT Filed: Oct. 22, 2010
(86) PCT No.: PCT/EP2010/006458

§ 371 Date: Jun. 29, 2012

(30) Foreign Application Priority Data
Oct. 22, 2009 (DE) 10 2009 050 420.6

(51) Int. Cl. B65D 85/00; B32B 27/32; A23L 1/00; B32B 27/36; B32B 27/30; B65B 63/08; B32B 27/34

(52) U.S. Cl. 426/531; 53/440; 206/459.5; 428/523; 428/474.4; 428/480; 428/500

(57) ABSTRACT

The invention relates to a process for the preparation of a closed container (3) which separates an interior space (1) from an environment (2) which is filled with food stuff from at least one sheetlike composite (7) which has at least one edge (4), comprising the steps:
a) provision of the sheetlike composite (7), comprising
   a1. at least one outer crosslinked plastic colour layer (9) comprising a colour agent (20);
   a2. a carrier layer (6); and
   a3. a thermoplastic plastic layer (37);
b) formation of the sheetlike composite (7) to obtain an open container (14), wherein the plastic colour layer (9) faces onto the environment (2) and the plastic layer (37) faces onto the interior space (1);
c) filling of the open container (14) with a food stuff;
d) closing of the open container (14) to obtain the closed, filled container (3);
e) preservation of the food stuff in the closed, filled container (3) in a pressure chamber under a chamber pressure of more than 1 bar at a temperature in a range from more than 100 to 140° C. in the presence of steam.

In general, the invention concerns a process for the preparation of a closed, filled container with at least a sheetlike composite having at least one edge, comprising the steps: Provision of a sheetlike composite, comprising a1. at least an outer crosslinked plastic colour layer which comprises colour agent, a2. a carrier layer, and a3. a thermoplastic plastic layer; shaping of the sheetlike composite to obtain an open container, filling of the container with a food stuff, closing of the container to obtain a closed, filled container, as well as the preservation thereof.

For a long time the preservation of food stuffs, be they food stuffs for human consumption or animal feed products, has been achieved by storing them in a tin or in a glass jar closed with a lid. In this connection, one way to achieve storage life is to separately sterilise as far as possible both the food stuff and the container, here the glass jar or the tin, and then fill the food stuff into the container and close the container. In another approach the food stuff is filled into the glass jar or tin and then sterilised as far as possible using heat treatment and the glass jar or tin sealed. In a further approach the food stuff is filled into the glass jar or tin and the glass jar or tin is sealed. Subsequently the sealed tin or closed glass jar with the food stuff present therein is exposed to a heat treatment, referred to as pasteurization, sterilisation or autoclaving, preferably an autoclaving mainly using superheated steam, in order to sterilise as far as possible the food stuff as well as the inner walls of the container which face onto the food stuff and the side of the sealing wall of the tin or the lid of the glass jar which faces onto the food stuff. However, these measures for increasing the storage life of food stuffs, which have for a long time proven valuable, have a number of disadvantages. Tins and glass jars have the disadvantage, due to their essentially cylindrical shape, that a close, space saving packing is not possible. In addition, tins and jars themselves have a considerable weight of their own, which leads to an increased energy expenditure in transportation. Moreover, the production of glass, tin or aluminium, even when raw materials come from recycling, requires a very high energy expenditure. To make matters worse where glass jars are concerned, there is additionally an increased transport expenditure. The glass jars are normally fabricated in a glassworks and must then be transported to the food stuff filling plant, the transport volume occupied being considerable. Furthermore, glass jars and tins can only be opened with considerable effort or with the help of tools, which is therefore laborious. With tins there is additionally a high risk of injury from sharp edges produced during opening. Time and time again with glass jars, slivers of glass get into the food stuff during the filling of glass jars or the opening of filled glass jars, which in the worse case can lead to internal injury on consumption of the food stuff.

Another concept for the storage of long life food stuffs is known from the prior art. Here containers are used which are made out of a multi layer laminar composite, often referred to as a laminate, in which particularly stiff paper, card or cardboard forms a structural layer which governs the form stability of these packagings. This type of packaging is disclosed, for example, in WO 97/02140, which discloses a process for the preparation of a folded, heat and moisture resistant container which is treated with the so called “Hot fill”-process (cf. Ullmann's Encyclopaedia of Industrial Chemistry, Vol. A 11, “FOODS”, 2. “Food Technology, 1988, sides 549 and 552, VCH Verlagsgesellschaft Weinheim). A further container made of a sheetlike composite with cardboard as structural layer is disclosed by WO 97/02181. Another container concept, similarly belonging to this group of containers made out of a sheetlike composite with cardboard as structural layer, is disclosed by DE-OS-24 12 447. WO 03/059622 A2 also discloses a container concept made of a sheetlike composite with cardboard as structural layer which is used for autoclaving.

These containers are often furnished with printed pictures or coloured decorations which, as well as providing information on the content of the container, are also supposed to make important aesthetic impressions on the end user of the food stuff contained in the container. It is particularly disadvantageous if these printed pictures suffer the most drastic of conditions during the preservation through autoclaving. In order to prevent this at least partially, WO 02/22462 A1 proposes the use of a protective finish introduced onto the colour layer. Similar concepts for a protective layer over the colour are also proposed by DE 102 52 553 B4, WO 98/51493 A1 as well as WO 2008/094085 A1.

In general, the inventive object of the present invention lies in the at least partial elimination of the disadvantages present in the prior art.

The present object was additionally to establish a process which allows the preparation of a closed, filled, and autoclaved container at minimal expense and with as little damage as possible to the printed pictures or colour decorations. As well as scratching and detachment of the printed pictures or colour decoration, a washing out of the colour during autoclaving should be avoided as far as possible, in order to ensure such a high autoclave resistance. In this connection, the process speed should remain as high as possible and preparation in as few printing facilities as possible, preferably in only one printing facility, preferably in continuous operation, also allows the high suitability of the container for receiving food stuffs to be ensured.

A contribution to the solution of at least one of the present objects is made by the subject matter of the category forming claims and subsequent embodiments. The subject matter of the sub claims which are dependent on the category forming claims represents preferred embodiments of this contribution to the solution.

A contribution to the solution of at least one of the present objects is made by a process for the preparation of a closed container, filled with food stuff, which closes off an internal space from an environment made of at least a sheetlike composite which has at least one edge, comprising the steps:
a) provision of the sheetlike composite, comprising
   a1. at least one outer, preferably outermost, crosslinked plastic layer which comprises colour agents;
   a2. a carrier layer; and
   a3. a thermoplastic plastic layer;
b) formation of the sheetlike composite to obtain an open container, wherein the plastic colour layer faces onto the environment and the plastic layer faces onto the internal space;
c) filling of the open container with the food stuff;
d) closing of the open container to obtain the closed, filled container;
e) preservation of the food stuff in the closed, filled container in a pressure chamber at a chamber pressure of more than 1 bar at a temperature in a range from more than 100 to 140° C. in the presence of steam.

According to the invention, the outer layer can by all means have further layers between the outer layer and the environment. The outermost layer, however, according to the invention, is in direct contact with the environment and no further layers, particularly protective layers, are present in between the outer layer and the environment. The outer plastic colour layer and the outermost plastic colour layer, along with the corresponding sheetlike composite, unfilled and filled container prepared therefrom, and preservation process, each constitute a separate embodiment according to the invention.

The containers according to the invention preferably have between 6 and 16 edges, preferably between 7 and 12 edges. According to the invention, edges will be particularly understood as areas arising from the folding of a surface where two parts of this surface are overlapping. For example, the oblong contact areas, in each case between two wall surfaces in an essentially cuboid container, are named edges. Such a cuboid container has, as a general rule, 12 edges. In the container according to the invention the walls of the container preferably represent the surfaces of the container which are bordered by edges. The container walls of a container according to the invention preferably have at least 50%, preferably at least 70% and most preferably 90%, of their area formed of a carrier layer.

Generally, the carrier layer of the container according to the invention can be made of those materials know by the person skilled in the art to be suitable for this purpose, which have sufficient rigidity and stiffness so as to give the container such stability that the container essentially maintains its form when filled. Along with a series of plastics, plant based fibrous materials are also preferred, in particular pulps, particularly glued laminated pulps, cardboard being particularly preferred.

In the container according to the invention the carrier layer forms a part of a sheetlike composite, which can also be referred to as a laminate, and is deployed in the form of an arch, jacket, or a long sheet during the preparation of the container.

The sheetlike composite normally has at least one thermoplastic plastic layer, or several, as well as 1 to 4 further thermoplastic plastic layers. Here all plastics come into consideration which are commonly known to the person skilled in the art, which can be melt extruded and which do not contribute to the delamination of the sheetlike composite under the conditions of the autoclaving. In this connection, preferred thermoplastics are polymers such as polyethylene (PE), polypropylene (PP), polyamide (PA), polyethyleneterephtalate (PET), ethylenelvinylalcohol (EVOH), and/or liquid crystal polymers (LCP) or a mixture of at least two thereof. Furthermore, it is preferred for the further plastic layer(s) to have a weight per surface area in a range from 2 to 120 g/m², preferably in a range from 5 to 75 g/m² and particularly preferably in a range from 10 to 55 g/m². It is further preferred that the further plastic layer(s) have a thickness in a range from 10 to 100 μm, preferably in a range from 15 to 75 μm and particularly preferably in a range from 20 to 50 μm.

Furthermore, the sheetlike composite can have one or more adhesive layers. These serve in particular to better bind the carrier layer to the barrier layer which is normally present. In principle, all materials known to the person skilled in the art and which are suited to binding through chemical bonding come into consideration as the adhesive, in particular those functionalised with OH—, NH₂—, COOH— or anhydride groups, preferably plastics which can be melt extruded, in particular maleic acid ethylene copolymers. Such adhesive agents come under the trade names Orevac®, Admer®, Lotader® or Plexar®. Different adhesive agents can also be mixed together to form a mixed adhesive agent.

Furthermore it is preferred for the container according to the invention to be sealable using a portion of the container wall. One way to achieve this is for the relevant area of the container wall to have foldable or bendable areas by virtue of which it may be sealed by pre-creasing and folding shut as well as fixing of the folded shut portion of the container wall. The fixing which seals the container can be achieved by sealing or bonding or a combination of both of these measures, and so securely that the container sealed in this way can not be readily opened in this area and a long storage life of the food stuff is obtained. The opening along the perforation before use of the food stuff can as such be much easier.

In another embodiment of the container of the process according to the invention it is preferred that at least 70% by volume, preferably at least 75% by volume and more preferably at least 80% by volume, of the volume of the container is made up of food stuff with an F₀ value from 0.01 to 50 and preferably in a range from 2 to 45.

Furthermore, in another embodiment of the container of the process according to the invention, the container wall is formed from a single carrier layer as part of the sheetlike composite. Here, the container can also, for example, be formed in its side walls of a sheetlike composite which has only a single carrier layer, the composite layer being fitted on the over and under side with a cap and a bottom made of another material.

In another form of the container of the process according to the invention, it is formed totally, preferably in one piece, out of a single carrier layer as part of the sheetlike composite. According to the invention, it is preferred that at least the polyamide layer, preferably at least one other layer and particularly preferably at least the polyamide layer and the carrier layer are present in one piece in the sheetlike composite of the container according to the invention. This applies in particular to cuboids containers, also referred to as “brick” as well as cuboid containers that possess a so called “gable-top” mainly used for opening.

According to a further embodiment, the container in the closed state is suitable for the storage of food stuffs. Such containers according to the invention which are closed and filled with food stuff allow this food stuff to be stored for a particularly long period of time.

The forming of the sheetlike composite and the obtaining of an open container can be achieved by any method which seems appropriate therefor by the person skilled in the art. In particular, the forming can be achieved by folding container blanks in sheet form which, in their pre-cut form, already take account of the form of the container in such a way that, via a jacket, an open container according to the invention is formed. This is generally achieved as follows. Following the folding of this container blank, the longitudinal edges of which are sealed or crimped into a jacket so as to form a side wall, one side of the jacket is closed by folding and further fixing, in particular, sealing or bonding.

In another embodiment of the process according to the invention, first a tube shaped structure with a fixed longitudinal seam is formed by folding and sealing or bonding of the overlapping hems. This tubular structure is laterally compressed, fixed and divided and thus an open container is likewise form by folding and sealing or bonding. Here, the food stuff can already be present after the fixing and before the division.

The open containers obtained in such a way can be filled with food stuff in different ways. In the process according to the invention it is further preferred that at least 70% by volume, preferably at least 75% by volume and most preferably at least 80% by volume of the volume of the container consist of food stuff.

The closing of the container filled with food stuff is preferably achieved by the folding and sealing or bonding of the portion which is present for this purpose in the open container, which preferably is likewise made out of the carrier layer or the sheetlike composite. Instead of sealing with a sealant plastic, in another embodiment of the process according to the invention other forms for the attachment are possible, for example by the application of a suitable bonding agent or adhesive which is normally a functionalised polymer and thus, in contrast to the physical binding of the sealing, also contributes a chemical bonding of the areas of the container according to the invention which are to be joined.

The preparation of the sheetlike composite can be achieved by any means which seem suitable to the person skilled in the art for manufacture of the container according to the invention. Thus the sheetlike composites can come in the form of a long sheet, normally unrolled from a roll, in the form of a tube or in the form of a container blank or jacket in a pre-cut form in contemplation of the form of the container.

In connection with the sheetlike composite it is preferable that the at least one barrier layer is joined to the carrier layer via a bonding layer. The sheetlike composite can be manufactured by any means which seem suitable to the person skilled in the art. Particularly preferred in this connection is for the individual layers to be worked together into the sheetlike composite via a co-extrusion process.

The individual layers of the sheetlike composite can follow each other in any way. Thus two and more of these layers can follow each other directly, that is to say not separated from each other by any further layers, or indirectly, that is to say separated from each other by one, two or more than two layers. Therefore at least two or even all of the layers of the sheetlike composite are either directly or indirectly joined to each other.

All materials known to the person skilled in the art which have a low gas permeability come into consideration for barrier layers. Barrier layer(s) made of a foil or further polymer layer such as polyethylenevinylalcohol (EVOH) are preferred. The foil can be a metal foil, a metallized foil, a silicon oxide gas-coated foil or a carbon gas-coated foil.

In a further embodiment of the process according to the invention the food stuff is preserved in the closed, filled container up to an F₀ value from 0.01 to 50 and preferably from 2 to 45.

Further, in an embodiment of the process according to the invention, the preservation is carried out under a chamber pressure of preferably at least more than 1.1 bar, preferably at least 1.2 bar and was also carried out in a range from 1.3 to 4 bar at a temperature in a range from preferably more than 102 to 137° C. and preferably in a range from 105 to 135° C. in the presence of steam. The duration of this preservation depends on the type, amount, volume, lump size of solid parts, viscosity and acidity of the food stuff. In general, the conditions are selected by the person skilled in the art such that the required F₀ values are attained. Normally the preservation is achieved with a holding time in a range from 0.5 seconds to 90 minutes, preferably 2 to 60 minutes and particularly preferably 5 to 40 minutes. It has proven particularly advantageous in the process according to the invention for the container to be agitated during the preservation. Through this agitation, which can for example be a rotation, tumbling and shaking, a mixing of the food stuff in the container, which often has solid and liquid components, is achieved and in this way a distribution of heat in the food stuff contained in the container is achieved which is as good and quick as possible and an adherence of clumped food stuff in the neck of the filled container according to the invention through local over-heating is avoided. Suitable means and equipment for the agitation of the container during the preservation is given, for example, in WO 2009/040347 A2.

In the method according to the invention it is preferred that the sheetlike composite is obtainable by a series of steps comprising:
provision of a pre-composite with a surface, comprising the carrier layer;
application of a liquid colour layer precursor onto the surface; and
curing of the coloured layer precursor into the plastic layer colour layer.

In connection with the pre-composite, which is also present in a laminar form, it is preferred, just as was the case for the previously described sheetlike composite, that it comprises, in addition to the carrier layer, at least one barrier layer, at least one further plastic layer and at least one adhesive layer. For this purpose, the aforementioned designs for the sheetlike composite are equally valid. The pre-composite often contains all of the layers of the sheetlike composite except for the outermost plastic colour layer.

Further, it is preferred in the process according to the invention that, before the application of the liquid colour layer precursor onto the surface, the surface is treated with a plasma. All plasma treatments known to the person skilled in the art which are suitable for increasing the hydrophilic nature of the surface come into consideration. In this way mostly peroxide, ketone, carboxyl, and other oxygen compounds are formed by the plasma treatment.

Furthermore, it is preferred in the process according to the invention, that the surface has a surface tension in a range from 36 to 44 Dyne and particularly preferably from 40 to 41 Dyne in accordance with DIN EN 14210/14370. Where the surface tension is too low, separation of the outer or outermost plastic colour layer can too easily occur, whereas where the surface tension is too high, organoleptic disadvantages can occur, especially if the sheetlike composites are stored for a long time as rolls or stacks.

Moreover, it is preferred in the process according to the invention that the colour layer precursor has a temperature during application in the range from 25 to 40° C., preferably in the range from 26 to 32° C. and particularly preferably in the range from 27 to 29° C. This also has an advantageous effect on the autoclave resistance.

Further, it is preferred in the process according to the invention that the liquid colour layer precursor has a viscosity in the range from 0.3 to 0.6 Pas and preferably in a range from 0.4 to 0.5 PaS. The viscosity is determined using a rotary viscometer in accordance with DIN 53019-1. The application of the colour layer precursor with such a viscosity leads to a uniform colour agent precursor layer. This has an advantageous effect on the autoclave resistance of the outer or outermost plastic colour layer.

Furthermore, it is preferred in the process according to the invention that the liquid colour layer precursor comprises as components
v1. a crosslinking component in the range from 30 to 80% by weight, preferably in a range from 35 to 75% by weight, particularly preferably in a range from 30 to 65% by weight;
v2. at least 16.89% by weight, preferably at least 18.9% by weight and particularly at least 22.5% by weight of a further component, different from v1, which is reactive with the crosslinking component;
v3. a colour agent in the range from 3 to 25% by weight, preferably in a range from 5 to 20% by weight and particularly preferably in a range from 7 to 18% by weight; and
v4. an initiator, preferably radical, particularly preferably photochemical, in the range from 0.1 to 20% by weight, preferably 1 to 17% by weight and particularly preferably in a range from 5 to 15% by weight;
v5. an additive that is different from v1. to v4. in the range from 0.01 to 5% by weight, preferably in a range from 0.1 to 3% by weight and particularly preferably in a range from 0.5 to 2.5% by weight,
   wherein the sum of the percentages by weight equals 100% by weight. It is further preferred that the colour layer precursor is made up of less that 20% by weight, preferably less than 10% by weight and particularly preferably less than 5% by weight, in each case in relation to the colour layer precursor, of solvent, or contains no solvent. Materials with a melting point less than 10° C. are considered as solvents. Quantities of solvent which are too high have a negative effect on the uniformity and autoclave resistance of the outer and outermost plastic colour layer. Therefore primarily solvent free colour layer precursors are preferred.

The crosslinking component v1. preferably has doubly functional or polyfunctional compounds. Suitable functionalizations are oxygen carrying groups, such as OH or COOH groups, or C—C double bonds. Particularly preferred crosslinking components are di-, tri- or tetraacrylates up to octaacrylates. These are normally formed from a polyalcohol, such as 1,2-propandiol, glycerol or pentaerythritol or di-, tri- or tetraglycerides, which optionally comprises a carbohydrate or alkyleneoxide spacer, normally a polyethyleneoxide or polypopyleneoxide, preferably each with 1 to 20 and particularly preferably 2 to 15 repeating units, and acrylic acid or an acrylic acid derivative, so that the double bond of the acrylic acid or of the acrylic acid derivative are present as functional group of the crosslinking component. Such acrylates are, for example, alkantriol(meth)acrylates such as 1,3-butyleneglycoldi(meth)acrylate, 1,4-butandioldi(meth)acrylate, 1,6-hexandioldi(meth)acrylate, trialkyleneglycoldi(meth)acrylate, polyalkyleneglycoldi(meth)acrylate, tetraalkyleneglycoldi(meth)acrylate, neopentylglycoldi(meth)acrylate, glycerinalkoxytri(meth)acrylate, alkoxylised neopentylglycoldi(meth)acrylate; (meth)acrylepoxide compounds such as bisphenol-A-epoxide-di(meth)acrylate; polyhydroxy(meth)acrylates such as pentaerythritoltri(meth)acrylate, trimethylolpropantri(meth)acrylate, trisalkoxytrimethylolpropantri(meth)acrylate, di-trimethylolpropantetra(meth)acrylate, pentaerythritoltetra(meth)acrylate, tris-(2-hydroxyalkyl)isocyanurattri(meth)acrylate, dipentaerythritoltetra(meth)acrylate, dipentaerythritolpenta(meth)acrylate, dipentaerythritolhexa(meth)acrylate, wherein alkylene means ethylene, propylene or butylene and alkoxy means ethoxy, 1,2- or 1,3-propoxy or 1,4-butoxy. A further group of crosslinking agents is represented by doubly and poly functionalised acrylamides. This can also have carbohydrate or alkylene oxide spacers. Some examples of crosslinking agents are N,N′-methylenebisacrylamide, polyethyleneglycoldi(meth)acrylates, triallylmethylammoniumchloride, tetraallylammoniumchloride as well as allylnonaethyleneglycolacrylate prepared with 2 mol ethyleneoxide per mol acrylic acid. Still more preferably, tri- and poly functional crosslinking agents are deployed in the process according to the invention, in order to effect a greater autoclave resistance of the outer or outermost plastic colour layer.

As further components v2, which are preferably mono functional compounds, particularly preferably with a C—C double bond, often also termed as monomers, all compounds known to the person skilled in the art and which are suitable for the process according to the invention can be used. Notably, these are mono functional acrylate compounds, thus the following (meth)acrylates can be used: linear, branched or cyclic alkyl (meth)acrylate as well as n-/isoalkyl(meth)acrylate, cyclohexyl(meth)acrylate, 4-tert.-butylcyclohexyl(meth)acrylate, dihydrocyclopentadienyl(meth)acrylate, tetrahydrofurfuryl(meth)acrylate, is obornyl(meth)acrylate, allyl(meth)acrylate, mono(meth)acryloylalkylphthalate, -succinate or -maleinate; alkandiolmono(meth)acrylates, such as hydroxypropyl(meth)acrylate, polyalkyleneglycol(meth)acrylate, monoalkoxytrialkyleneglycol(meth)acrylate, 2,3-epoxypropyl(meth)acrylate; aromatic (meth)acrylates such as nonylphenol(meth)acrylate, 2-phenoxyalkyl(meth)acrylate; acrylamides such as N,N-dialkyl(meth)acrylamide, N,N-dialkylaminoalkyl(meth)acrylamide. Furthermore, vinylethers can be employed in part, such as e.g. vinylethylether, vinylpropylether, vinylisobutylether, vinyldodecylether, butandiol-1,4-divinylether, diethyleneglycoldivinylether, hydroxybutylvinylether. The monomeric acrylate compounds can be present individually or mixed, wherein the total should lie between 5 to 60% in particular between 5 to 50% by weight.

As colour agent v3., both solids and liquids known to the person skilled in the art and which are suitable for the present invention come into consideration. Solid colour agents are often referred to as colour pigments and are separated into organic and inorganic colour pigments.

The following are notable suitable pigments: i. red or magenta pigments: Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50 and 88; ii. blue or cyan pigments: Pigment Blue 1, 15, 15:1, 15:2, 15:3, 15:4, 15:6, 16, 17-1, 22, 27, 28, 29, 36 and 60; iii. green pigments: Pigment Green 7, 26, 36 and 50; iv. yellow pigments: Pigment Yellow 1, 3, 12, 13, 14, 17, 34, 35, 37, 55, 74, 81, 83, 93, 94, 95, 97, 108, 109, 110, 128, 137, 138, 139, 153, 154, 155, 157, 166, 167, 168, 177, 180, 185 and 193 and v. white pigments: Pigment White 6, 18 and 21.

As initiators v4., those initiators, preferably photoinitiators, known to the person skilled in the art can be employed, preferably radical initiators, such as for example, 2-benzyldimethylamino-1-(4-morpholinophenyl)-butanone-1, benzildimethylketal-dimethoxyphenylacetophenone, alpha-hydroxybenzylphenylketone, 1-hydroxy-1-methylethylphenylketone, oligo-2-hydroxy-2-methyl-1-(4-(1-methylvinyl)phenyl)propanone, benzophenone, methylorthobenzoylbenzoate, methylbenzoylformate, 2,2-diethoxyacetophenone, 2,2-di-sec.-butoxyacetophenone, p-phenylbenzophenone, 2-isopropylthioxanthone, 2-methylanthraquinone, 2-ethylanthraquinone, 2-chloranthraquinone, 1,2-benzanthraquinone, benzill, benzoin, benzoinmethylether, benzoinisopropylether, α-phenylbenzoin, thioxanthone, diethylthioxanthone, 1,5-acetonaphthaline, 1-hydroxycyclohexylphenylketone, ethyl-p-dimethylaminobenzoate. Suitable photopolymerization initiators include a series of substances which have proven to be useful in practice. To this series belong benzoin compounds such as benzoin, benzomethylether, benzoinmethylether, carbonyl compounds such as benzil, benzophenone, acetophenone or Michler's ketone, azo compounds such as azobisisobutyronitrile or azodibenzoyl, sulphur compounds such as dibenzothiazolylsulphide or tetraethylthiuramdisulphide, halogen compounds such as tetrabromomethane or tribromophenylsulphone and 1,2-benzanthraquinone. Peroxides which are used in preference include almost all organic compounds with one or more oxygen-oxygen bonds in the molecule. Examples thereof are methylethylketoneperoxide, cyclohexanoneperoxide, 3,3,5-trimethylcyclohexanoneperoxide, methylcyclohexanoneperoxide, acetylacetoneperoxide, 1,1-bis-(t-butylperoxy)3,3,5-trimethylcyclohexane, 1,1-bis(t-butylperoxy)-cyclohexane, n-butyl-4,4-bis(t-butylperoxy)valerate, 2,2-bis(t-butylperoxy)butane, t-butylhydroperoxide, cumenehydroperoxide, diisopropylbenzolhydroperoxide, p-menthanehydroperoxide, 2,5-dimethylhexane-2,5-dihydroperoxide, 1,1,3,3-tetramethylbutylhydroperoxide, di-t-butylperoxide, t-butylcumylperoxide, dicumylperoxide, α,α′-bis(t-butylperoxyisopropyl)benzene, 2,5-dimethyl-2,5-di-(t-butylperoxy)hexane, 2,5-dimethyl-2,5-di-(t-butylperoxy)hexan-3, acetylperoxide, isobutyrylperoxide, octanoylperoxide, decanoylperoxide, lauroylperoxide, 3,5,5-trimethylhexanoylperoxide, peroxysuccinic acid, benzoylperoxide, 2,4-dichlorobenzoylperoxide, m-toluoylperoxide, diisopropylperoxydicarbonate, di-2-ethylhexylperoxydicarbonate, di-n-propylperoxydicarbonate, di-2-ethoxyethylperoxydicarbonate, dimethoxy-isopropylperoxycarbonate, di(3-methyl-3-methoxybutyl)peroxydicarbonate, t-butylperoxyacetate, t-butylperoxyisobutyrate, t-butylperoxypivalate, t-butylperoxyneodecanoate, t-butylperoxyoctanoate, t-butylperoxy-3,5,5-trimethylhexanoate, t-butylperoxylaurate, t-butylperoxybenzoate, di-t-butyl-diperoxyisophthalate, 2,5-dimethyl-2,5-di(benzoylperoxy)hexane, t-butylperoxymaleic acid and t-butylperoxyisopropylcarbonate. Of the above the organic peroxides benzoyl group containing organic peroxides are preferred e.g. t-butylperoxybenzoate, di-t-butyl-diperoxyisophthalate, 2,5-dimethyl-2,5-di(benzoylperoxy)hexane, benzoylperoxide, 2,4-dichlorobenzoylperoxide and m-toluoylperoxide. Of the benzoyl group containing organic peroxides peroxyester type organic peroxides are particularly preferred, e.g. t-butylperoxybenzoate, di-t-butyl-diperoxyisophthalate and 2,5-dimethyl-2,5-di-(benzoylperoxy)hexane. The above mentioned compounds can be used individually or in a mixture of at least two thereof.

Particularly preferred in the process according to the invention are crosslinking components and other components which yield a crosslinked polyester which is preferably based on acrylates and preferably obtained by radical polymerisation and in particular which is crosslinked. Notable commercial examples are the products Sicura® or Tempo® of Siegwerk Druckfarben AG, Germany.

As additive, all those known to the person skilled in the art which are used for printing applications come into consideration. Preferably, waxes, soaps or tensides are employed, and stabilisers are employed for increasing the storability of the colour layer precursor. Often the additives have a melting point above 30° C. and preferably above 50° C. The viscosity and surface tension of the liquid colour layer precursor can be set using the additives.

The application of the liquid colour layer precursor can be achieved by any printing process known to the person skilled in the art. Of particular note as printing process are flat printing, digital printing, relief printing or depression printing, preferably relief printing. It is preferred in the process according to the invention that the liquid colour layer precursor is applied to the surface by means of a rubbery area. The rubbery area is preferably formed using the surface of a printing cylinder. The rubbery area preferably has raised bumps which apply the colour layer precursor to the surface and in this way follow the principle of depression printing. The rubbery area is preferably furnished with colour layer precursor via an anilox roll. In this way, as uniform as possible an application of the colour layer precursor can be achieved. This process is often referred to as “flexo printing”. In a further embodiment of the process according to the invention it is preferable to use depression printing.

The outer or outermost crosslinked plastic colour layer is often the outermost layer of a colour system which has 2 to 8, preferably 3 to 6 plastic colour layers of different colours. Using several plastic colour layers of different colours, mostly primary colours, various combination colours can be created on the surface of the sheetlike composite. Provided that the colour system has two or more plastic colour layers, the one or more plastic colour layers next to the outer or outermost crosslinked plastic colour layer can have the same composition as outer or outermost crosslinked plastic colour layer except for the colour. Furthermore, the application of the liquid colour layer precursor can be repeated according to the number of plastic colour layers.

Furthermore it is preferred in the process according to the invention that the surface is a crosslinked primer plastic layer, optionally filled with inorganic particles. Preferably, the primer plastic layer contains less colour agent than the plastic colour layer and can also contain no colour agent. In the case that the primer colour layer comprises inorganic particles, it preferable for them to have a particle size in a range from 3 to 12 μm and particularly preferably a particle size in a range from 3 to 7 μm. As inorganic particles, all metal oxides and sulphates which appear suitable to the person skilled in the art come into consideration. Notable metal oxides are SiO compounds, such as Aerosil or clay, TiO₂ or AlO compounds, such as Al₂O₃. As metal sulphates BaSO₄ and CaSO₄ in particular are considered. In addition to the white colour of the inorganic particles, it is preferred that these are hydrophilated with oxygen groups, preferably OH groups. Both the filled primer plastic layer and the plasma treatment, which can alternatively both be present in the pre-composite, serve to increase the mechanical durability during autoclaving of the plastic colour layer present thereon. As well as the hydrophilation the addition of inorganic, mostly white, particles to the primer plastic layer serves to ensure the colour fastness of the outer or outermost plastic colour layer and in particular to avoid its decoloration.

In the process according to the invention it is further preferred that, at least at the beginning, preferably during the curing, the colour layer precursor is present in an inert atmosphere. In this regard it is further preferred that the inert gas atmosphere has a residual oxygen content of less than 1000 ppm, preferably less than 500 ppm and particularly preferably less than 200 ppm and most preferably less than 100 ppm. The low oxygen content or even an oxygen free inert atmosphere has an advantageous effect on the autoclave resistance of the outer or outermost plastic colour layer. As inert gases for the inert gas atmosphere, nitrogen, argon or carbon dioxide or mixtures thereof come into consideration, nitrogen being particularly preferred. In the process according to the invention, the inert gas atmosphere is preferably created by applying an inert gas or inert gases to the moving surface which has the liquid colour layer precursor present, the inert gas(es) being applied in a different direction, preferably in a direction opposite to the motion, preferably as a counter flow. This is achieved by one or more nozzles present above the liquid colour layer precursor layer, wherein these are preferably displaced above the colour layer precursor layer by less than 10 mm, preferably less than 5 mm and particularly preferably less than 2 mm, but which should not, however, come into contact with the liquid colour layer precursor layer. Generally, the pre-composite is moved or driven with a speed of at least 250, preferably at least 300 and particularly preferably at least 350 m/min and normally not faster than 500 m/min in the process according to the invention.

The outer or outermost colour agent plastic layer is created by a radical polymerisation, preferably photoinitiated. In this connection it is preferred that the irradiation is also carried out in the inert atmosphere. To this end it is preferred that the surface with the liquid colour layer precursor layer is passed underneath the radiation source(s) and these are preferably enclosed, wherein the radiation sources preferably form part of the casing in order to further contribute to the autoclave resistance of the plastic colour layer.

Any radiation source known to the person skilled in the art and which is suitable for curing by photoionized radical crosslinking polymerisation is employed in the process according to the invention. UV radiation sources are preferred, preferably those in the range from 220 to 460 nm. It is particularly preferred to employ radiation sources which emit in at least two, preferably in all of the following wavelength ranges i. 220 to 230 nm, ii. 250 to 270 nm, ii. 310 to 330 nm, iv. 360 to 370 nm or v. 400 to 410 nm.

Further, it is preferred in the process according to the invention that the irradiation is followed by a heat treatment at a temperature in a range from 80 to 160° C., preferably in a range from 100 to 140° C. and particularly preferably in a range from 110 to 130° C. In connection with the curing it is further preferred to expose the colour layer precursor to a curing dose from 5 to 16 mW/cm² and particularly preferably from 5 to 8 mW/cm². For further curing, further heatings in a range from 200 to 240 W/cm are suitable, and particularly preferably in a range from 210 to 230 W/cm, preferably using an air steam acting on the colour layer precursor layer requiring further curing.

Additionally, it is preferable in the process according to the invention that the plastic colour layer has a surface weight in a range from 0.4 to 15 g/m² and particularly preferably in a range from 0.5 to 1.5 g/m². To this end it is similarly advantageous to apply the colour layer precursor in a range from 0.4 to 15 g/m² and particularly preferably in a range form 0.5 to 1.5 g/m².

Moreover, it is preferred in the process according to the invention that the plastic colour layer has a thickness in a range from 0.4 to 15 μm and preferably in a range from 0.5 to 1.5 μm. To this end it is similarly advantageous for the colour layer precursor to be applied in a range from 0.4 to 15 μm and particularly preferably in a range from 0.5 to 1.5 μm. The thickness is determined by means of incisions.

The above mentioned measures of the process according to the invention, individually or as a combination of at least two of these measures, contribute to an increase in the resistance of the subsequently produced plastic colour layer during autoclaving. Too hard a plastic colour layer often leads to a peeling off of areas of plastic colour layer, since these become too brittle under the autoclaving conditions or do not bind sufficiently from the outset. The binding can be determined according to DIN EN ISO 2409. Too soft a plastic colour layer, on the other hand, often leads to a scratching of plastic colour layer regions since this is caused, under the conditions of the autoclaving, in particular by mechanical stress such as rubbing or chafing with the container mountings and particularly in an autoclaving in which the container is agitated. The abrasion resistance can be determined according to ASTM D5264-98.

A further contribution to the solution of at least one of the aforementioned objects is made by a sheetlike composite, comprising
V1. at least an outer crosslinked plastic colour layer comprising a colour agent;
V2. a carrier layer; and
V3. a thermoplastic plastic layer;
wherein a crosslinked primer plastic layer, preferably comprising inorganic particles, is present in between the plastic colour layer and the carrier layer.

It is preferable according to the invention in connection with the sheetlike composite that the plastic colour layer has a surface with a contact angle of greater than 50°, preferably between 50 to 85°, particularly preferably 65 to 80° and most preferably 70-75°. The contact angle is determined according to the method described here. Generally a sheetlike composite is thus provided which comprises a plastic colour layer, wherein the plastic colour layer has a surface with a contact angle greater than 50°, preferably in a range from 60 to 80° and particularly preferably in a range from 65 to 75°. Such sheetlike composites are particularly suited as containers for autoclaving of food stuffs contained therein, and in so doing the colour and the information content on the containers are only marginally damaged, if at all. Therefore, containers made of sheetlike composites are employed in processes wherein food stuffs are autoclaved in these containers, in particular when these containers have been formed by folding a single piece of these composites, the above detailed conditions for the autoclaving being particularly preferable.

A further embodiment of the present invention relates to a container which is at least partially constructed from a sheetlike composite according to the invention. The container according to the invention preferably comprises food stuff.

The embodiments given above in connection with the process according to the invention apply similarly to the sheetlike composite as a product, as well as for the constituents thereof and for the container formed therefrom. Likewise, the additional embodiments for the product and the container also apply to the process according to the invention.

Moreover, it is preferred that the primer plastic layer, after being formed, for example by curing, has a layer thickness in a range from 0.5 to 5 μm, preferably in a range from 1.25 to 2 μm and particularly preferably in a range from 1.6 to 1.7 μm. As is the case with the other layers of the sheetlike composite, the layer thickness of the primer plastic layer can be determined by means of an incision in the sheetlike composite.

The primer plastic layer can be obtained by any means which seems appropriate to the person skilled in the art. Preferably it is obtained by application of a primer plastic precursor to the surface of a corresponding precursor to the sheetlike composite upon which the plastic colour layer which follows the primer plastic layer is intended to be present. Therefore it is preferred according to the invention that the liquid primer layer precursor comprises as components
Pv1. a cross linking component in a range from 30 to 63% by weight, preferably in a range from 35 to 45% by weight and particularly preferably in a range from 30 to 43% by weight, preferably one which reacts as a radical;
Pv2. at least 16.89% by weight, preferably at least 18.9% by weight and particularly at least 22.5% by weight of a further component distinct from Pv1. capable of reacting with the crosslinking component;
Pv3. in organic particles in a range from 20 to 55% by weight, preferably in a range from 30 to 50% by weight and particularly preferably in a range from 35 to 45% by weight; and
Pv4. an initiator, preferably a radical initiator, particularly preferably a photochemical initiator, in a range from 0.1 to 20% by weight, preferably 1 to 17% by weight and particularly preferably in a range from 5 to 15% by weight;
Pv5. an additive which is distinct from Pv1. to Pv4. in a range from 0.01 to 5% by weight, preferably in a range from 0.1 to 3% by weight and particularly preferably in a range from 0.5 to 2.5% by weight,
   wherein the sum of the percentages by weight of the components equals 100% by weight.

Preferably not just the primer layer precursor, but also the crosslinked primer plastic layer have more inorganic particles than the plastic colour layer, preferably at least 10% by weight and particularly preferably at least 50% by weight. Consequently, a primer plastic layer with inorganic particles, in particular white pigment, in a range from 20 to 55% by weight, preferably in a range from 30 to 50% by weight, and particularly preferably in a range from 35 to 45% by weight, in each case in relation to the primer plastic layer, is particularly preferred according to the invention. In this way a particularly good resilience of the plastic colour layer a with brilliant colour impression is obtained.

Furthermore, a double or poly isocyanate is added to the primer layer precursor at 1 to 25% by weight, preferably 2 to 15% by weight and particularly preferably 5 to 10% by weight, in each case relative to the primer layer precursor. This is preferably effected prior to the application of the primer layer precursor onto the surface of the relevant sheetlike composite precursor. There should preferably be no more than 2 days, preferably not more than 1 day and particularly preferably not more than 12 hours between the addition and the application.

As double or poly isocyantes all those known to the person skilled in the art and which he considers suitable for polyurethane formation come into consideration. These can, for example, be diphenylmethanediisocyanate (MDI), polymeric diphenylmethanediisocyanate (PMDI), toluoylenediisocyanate (TDI), naphthylenediisocyanate (NDI), hexamethylenediisocyanate (HDI), isophoronediisocyanate (IPDI) or 4,4′-diisocyanatodicyclohexylmethane (H12MDI) or at least two thereof.

The following exemplary figures show:

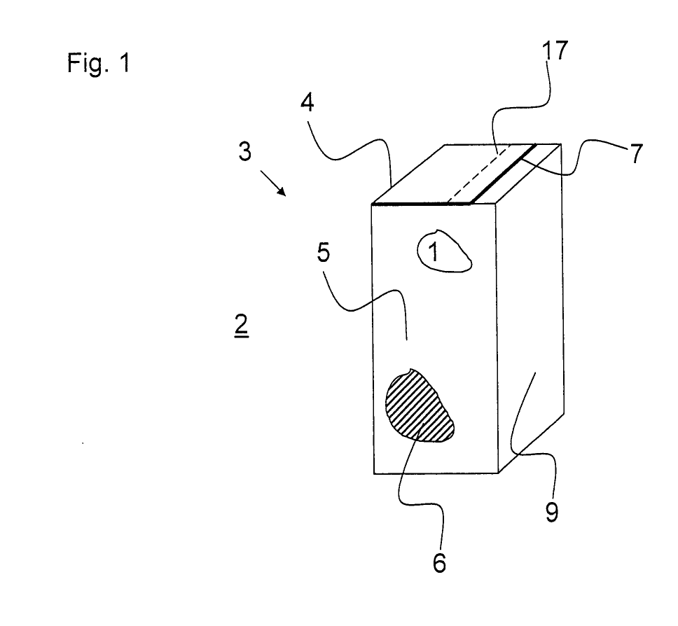

FIG. 1 a perspective view of a container obtainable by the process according to the invention;

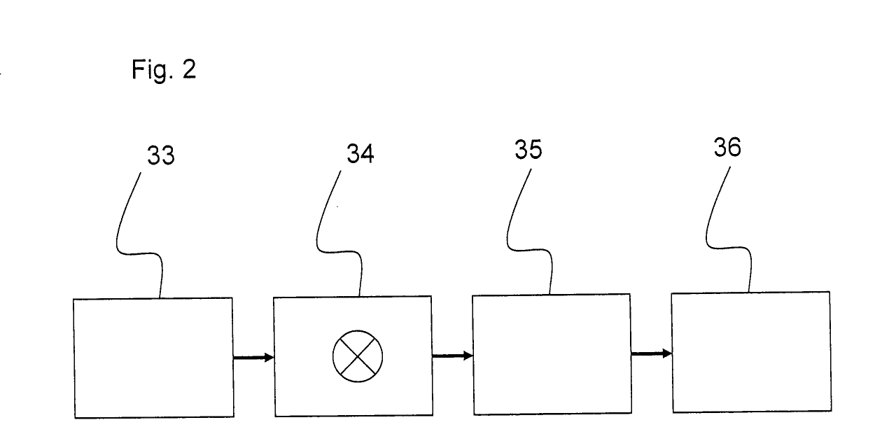

FIG. 2 a schematic representation of the course of the process according to the invention;

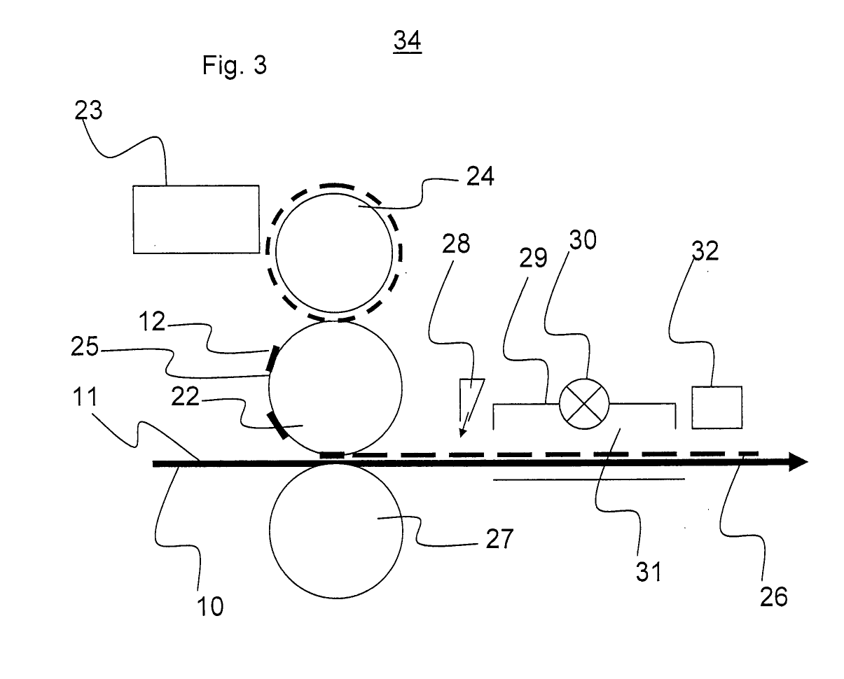

FIG. 3 a schematic representation of an apparatus for the application of the plastic colour layer;

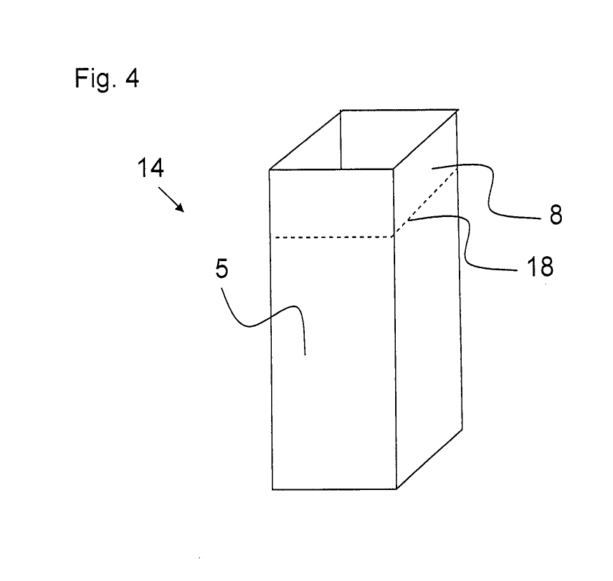

FIG. 4 a perspective view of an open container obtainable by the process according to the invention;

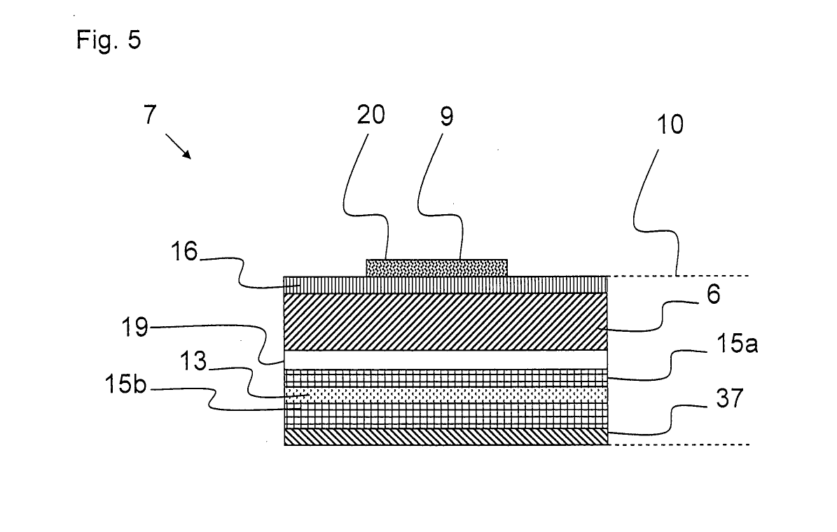

FIG. 5 a schematic cross section through a sheetlike composite with an outermost plastic colour layer;

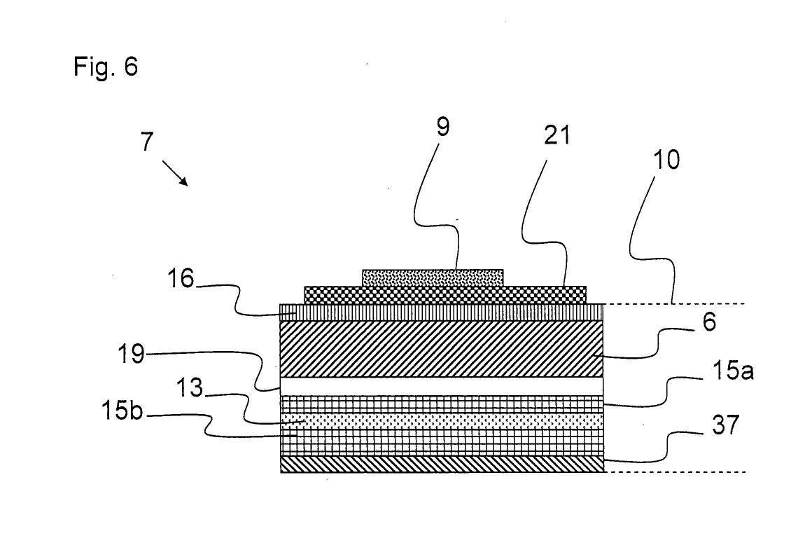

FIG. 6 a schematic cross section through a sheetlike composite with an outermost plastic colour layer;

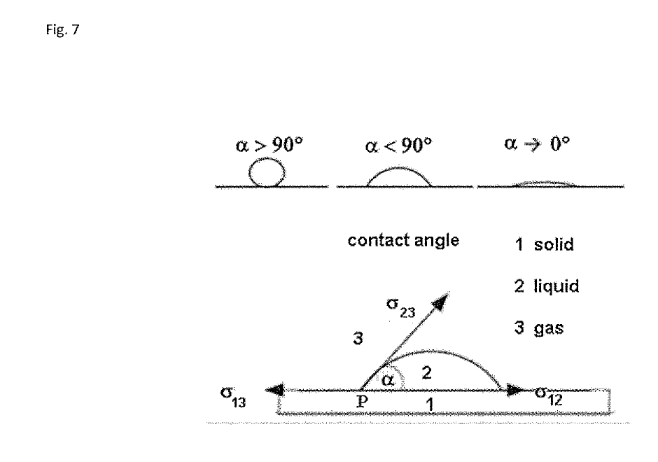

FIG. 7 schematic representation of contact angle determination.

FIG. 1 shows the perspective view of a container 3 obtainable by the process according to the invention which is essentially cuboid shaped and has a multiplicity of edges 4, which form the border between container walls 5 and as such create an interior space 1, which is separated from the environment by the container 3. The walls of the container 5 have a single piece carrier layer 6 running through the entire sheetlike composite 7 made out of cardboard, shown schematically as an excerpt, and an outermost crosslinked plastic colour layer 9. On the top side of the container 3a linear perforation 17 is present for easy opening of the container.

Firstly, the manufacture of a pre-composite 33 is detailed in FIG. 2. It shows an apparatus in which a pre-composite 10 is manufactured, for example those described more closely in FIGS. 5 and 6, normally by melt co-extrusion. This is accompanied by a printing unit 34 which is described in more detail in FIG. 3 and in which the plastic colour layer 9 is applied to the pre-composite 10, in order to produce the printed picture or decoration 26. Following this is a filling area 35 in which the packaging blank produced in the printing unit 34 is converted into an open container 14, for example as represented in FIG. 4, by folding and sealing or bonding, in order to be filled with the food stuff and subsequently sealed by folding and sealing or bonding. Included in the filling area 35 is an autoclave area 36. Here, the closed container 3, which is filled with food stuff, is autoclaved under pressure and in a moist atmosphere, this preferably being carried out in a pressure chamber which is particularly preferably designed for agitating the container, in particular through rotation. The production of the pre-composite 33 and the printing unit 34 are often spatially separated from the filling area 35 and the autoclave area 36. In this case it is preferred that the filling area 35 and the autoclave area 36 are provided at a food processing facility.

FIG. 3 exemplifies a printing unit 34 for the production of a plastic colour layer. Therein colour layer precursor is put onto an anilox roll 24 from a colour layer precursor reservoir 23, in order to create a suitably thin colour layer precursor film on the anilox roller 24 which is removed in sections by a flexible high pressure roller 22 with a flexible surface 25 and the sections placed onto a section of the surface 11 of a pre-composite 10, where the pre-composite 10 passes through the flexible high pressure roller 22 and the backing roller. Following on in the direction of motion of the pre-composite 10, after the application of colour layer precursor(s) 12 to the pre-composite 10 to give a printed picture or decoration 26, there is an inert gas jet 28, which blows an inert gas, preferably nitrogen, onto the blank 10 which is printed with the colour layer precursor 25, preferably in the opposite direction to that of the motion of the pre-composite 10, as shown by the directions of the arrows. Further on in the direction of motion of the pre-composite an enclosure 29 is included which accommodates a radiation source 30 and which encloses the pre-composite 10 with colour layer precursor 25 which passes through this enclosure 29 both from above and from below in order to ensure that an inert gas atmosphere 31 is formed in the enclosure 29. Further along in the direction of the motion of the pre-composite 10, and attached to the enclosure 29, is arranged a warm air blower 32. First, a radiation induced, preferably radical, crosslinking reaction of the colour layer precursor 25 occurs in the enclosure 29, and the colour layer precursor 25 is again thermally post treated by the warm air blower 32.

FIG. 4 shows the perspective schematic view of an open container 14, wherein the container wall 5 has a sealable portion 8 which is separated by a folded edge 18.

A preferred embodiment of a sheetlike composite 7 to be employed for the container of the process according to the invention is shown in FIG. 5. In the sheetlike composite of this preferred embodiment in the closed container 3, there follows in order, from outside to inside, a partially present plastic colour layer 9 which corresponds to the printed pattern or decoration 26, with colour agent 20 which is preferably made out of fine particle pigment, a further plastic layer 16, a carrier layer 6, an additional layer 19, a first adhesive layer 15a, an aluminium layer as a barrier layer 13, a second adhesive layer 15b and a further thermoplastic plastic layer 37. The pre-composite 10, upon which the plastic colour layer 9 is present, has the composition shown between the stroked lines.

In FIG. 6 is shown a further embodiment of a sheetlike composite for a container of the process according to the invention. In addition to the layers shown in FIG. 5, this sheetlike composite has a primer plastic layer 21 between the thermoplastic plastic layer 16 and the plastic colour layer.

Suitable adhesive agents are in particular thermoplastic polymers, preferably polyolefins, in particular polyethylenes, and polypropylenes or a mixture thereof, which are functionalised in order to form as secure a bonding as possible with the bordering layers by means of a chemical reaction. Preferred adhesive agents are polyethylene or polypropylene, which in each case in copolymerised with a function carrying monomer, in particular maleic acid anhydride. Such adhesive agents are grouped under the trade names Orevac®, Admer®, Lotader® or Plexar®. Different adhesive agents can also be mixed together to give an adhesive agent blend.

The further plastic layer or layers and the additional layer or layers are preferably made out of thermoplastic polymers. Here come into consideration, generally, all those known to the person skilled in the art for the production of a sheetlike composite, in particular when this is to be formed into a container, which is to be subjected to heat and moisture treatment filled or not filled with food stuff. Suitable thermoplastic polymers are polymers obtained by chain-polymerisation, polyolefins in particular, polycyclic olefin co-polymer (POC), polyethylene and polypropylene being preferred. Products of poly-condensation reactions or poly ring opening reactions are similarly suitable as thermoplastic polymers, with polyamides, polyesters and polyurethanes being particularly preferred. As polyurethanes, thermoplastic polyurethanes are preferred, preferably with a weight average molecular weight in a range from 2,000 to 2,000,000 g/mol and particularly preferably 4,000 to 50,000 g/mol. The polyurethanes preferably have a density in a range from 1.01 to 1.40 and particularly preferably in a range from 1.08 to 1.25 g/cm³. Polyurethanes of this type are commercially obtainable under the trade name Elastogran®. Particularly suitable polyesters are polybutyleneterephthalate, polycarbonate, polyethyleneterephthalate, polyethylenenaphthalate and preferably polyethyleneterephthalate. Polyesters have weight average molecular weights in a range from 5,000 to 2,000,000 g/mol and preferably in a range from 8,000 to 100,000 g/mol and densities in a range from 1.25 to 1.70 and preferably in a range from 1.30 to 1.45 g/cm³. A typical, commercially available polyester is CLEARTUF® P60. Additionally, mixtures of polymers obtained from chain-polymerisation and polymers obtained by poly-condensation reactions or poly ring opening reactions are suitable polymers according to the invention. Polymers obtained by chain-polymerisation are, however, preferred. In a further modification of the present invention the adhesive agents are present as a mixture with the thermoplastic polymers.

Preferred polyethylenes are HDPE, LDPE, LLDPE, and PE as well as mixtures of at least two thereof. Preferred polypropylenes are isotactic, syndiotactic and atactic polypropylenes as well as mixtures of at least two thereof. Preferred polyesters are acrylate based polyesters. Generally, the thermoplastic polymers for the various layers of a sheetlike composite for the manufacture of a container according to the invention are selected in such a way that they have a melting point that lies above the temperature load to which the container is exposed in the process according to the invention.

### Measuring Methods:

Generally, where they are not here otherwise specified, all measurements are carried out at 22° C., under atmospheric pressure and with a room humidity in a range from 50 to 70%. Wherever no measuring method is given here, the most recent ISO standard as of 10 Oct. 2009 applies for the determination of the relevant quantity.

### Determination of Contact Angle:

The determination is made according to TAPPI T558 om-06 with the following proviso: A drop of water (4 μl volume) is placed on the surface to be determined (here the plastic colour layer). After a settling time of roughly 500 ms the sample which is lying on the sample plate with the droplet lying on top is digitally captured by a camera whose optical axis cuts the cross section of the sample (see FIG. 7). The level is marked by hand, the evaluation of the angle is undertaken by the software of the apparatus used for the measurement OCA 20 (Dataphysics), which investigates the contact angle α of the corresponding sample.

### LIST OF REFERENCES

1 interior space
2 environment/outer side of container
3 container
4 edge
5 container wall
6 carrier layer
7 composite
8 sealable portion
9 plastic colour layer
10 pre-composite
11 surface
12 colour layer precursor
13 barrier layer
14 open container
15 adhesive agent a, b
16 thermoplastic plastic layer
17 perforation
18 folding edge
19 additional layer
20 colour agent
21 primer plastic layer
22 flexible high pressure roller
23 colour layer precursor reservoir
24 anilox roll
25 flexible surface
26 decoration
27 backing roll
28 inert gas nozzle
29 enclosure
30 radiation source
31 inert gas atmosphere
32 warm air blower
33 pre-composite manufacture
34 printing unit
35 filling area
36 autoclave area
37 further thermoplastic plastic layer

1. A process for the preparation of a closed container, which separates an internal space filled with food stuff from an environment, from at least one sheetlike composite which has at least one edge, comprising the steps:
a) providing a sheetlike composite comprising
a1. at least one outer crosslinked plastic colour layer, comprising a colour agent;
a2. a carrier layer; and
a3. a thermoplastic plastic layer;
b) forming the sheetlike composite to obtain an open container, wherein the plastic colour layer faces onto the environment and the thermoplastic plastic layer faces onto the internal space;
c) filling the open container with a food stuff;
d) closing the open container to obtain the closed, filled container; and
e) preserving the food stuff in the closed, filled container in a pressure chamber under a chamber pressure of more than 1 bar at a temperature in a range from more than 100 to 140° C. in the presence of steam.

2. The process according to claim 1, wherein the outer plastic colour layer is an outermost plastic colour layer.

3. The process according to claim 1, wherein the composite is obtainable by a series of steps comprising:
providing a pre-composite with a surface, comprising the carrier layer;
applying a liquid colour layer precursor onto the surface; and
curing the colour layer precursor into the plastic layer colour layer.

4. The process according to claim 3, wherein at least at the beginning of curing the colour layer precursor lies in an inert gas atmosphere.

5. The process according to claim, wherein the curing is effected using irradiation.

6. The process according to claim 5, wherein the irradiation is followed by a heat treatment at a temperature in a range from 80 to 160° C.

7. The process according to claim 3, wherein the surface is treated with a plasma before the application of the liquid colour layer precursor onto the surface.

8. The process according to claim 3, wherein the surface has a surface tension in a range from 38 to 44 Dyne.

9. The process according to claim 3, wherein the liquid colour layer precursor has a viscosity in a range from 0.3 to 0.6 Pa·s.

10. The process according to claim 3, wherein the liquid colour layer precursor contains as components
v1. a crosslinking component in a range from 3 to 25% by weight;
v2. at least 16.89% by weight of a further component which can react with the crosslinking agent and which is different from v1.;
v3. a colour agent in a range from 3 to 25% by weight;
v4. a polymerisation initiator; and
v5. at least one additive which is different from v1. to v4. in a range from 0.01 to 5% by weight,
wherein the sum of the percentages by weight of the components equals 100% by weight.

11. The process according to claim 3, wherein the liquid colour layer precursor is applied to the surface by means of a rubbery area.

12. The process according to claim 3, wherein the surface is a crosslinked primer plastic layer.

13. The process according to claim 1, wherein the plastic colour layer has a surface weight in a range from 0.4 to 15 g/cm².

14. The process according to claim 1, wherein the plastic colour layer has a thickness in a range from 0.5 to 2 μm.

15. The process according to claim 1, wherein at least 70% by volume of the internal space of the container is made up of a food stuff.

16. The process according to claim 1, wherein the container is made of a single carrier layer as part of the sheetlike composite.

17. The process according to claim 1, wherein the container is entirely made out of the carrier layer as part of the sheetlike composite.

18. The process according to claim 1, wherein the food stuff is preserved to an F₀ value from 0.01 to 50.

19. The process according to claim 1, wherein the closed, filled container is agitated during the preserving step.

20. A sheetlike composite, comprising
V1. at least one outer crosslinked plastic colour layer comprising a colour agent;
V2. a carrier layer; and
V3. a thermoplastic plastic layer;
wherein a crosslinked primer plastic layer is present between the plastic colour layer and the carrier layer.

21. The sheetlike composite according to claim 20, wherein the plastic colour layer has a surface with a contact angle greater than 50°.

22. A container at least partially constructed from a sheetlike composite comprising
V1. at least one outer crosslinked plastic colour layer comprising a colour agent;
V2. a carrier layer; and
V3. a thermoplastic plastic layer;
wherein a crosslinked primer plastic layer is present between the plastic colour layer and the carrier layer.

23. The container according to claim 22, wherein the container contains a food stuff.
